(19) United States
(12) Patent Application Publication
(10) Pub. No.: US 2004/0025012 A1
(43) Pub. Date: Feb. 5, 2004

(54) System for processing coded content and associated decoding instructions on a removable storage medium

(76) Inventor: David Patrick Burks, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/208,596

(22) Filed: Jul. 30, 2002

(51) Int. Cl. H04L 9/00

(52) U.S. Cl. 713/161

(57) ABSTRACT

Embodiments of the present invention provide a system and method for processing coded video data stored on removable storage media. In an exemplary embodiment, the system comprises a system manger configured to receive inputs from a user of the system and, in response to the inputs, to read organizational structure information stored on a removable storage medium. The system manager is further configured to identify a set of coded video data stored on the removable storage medium based on the inputs and the organizational structure information. The system manager is further configured to retrieve instructions from a decoding application stored on the removable storage medium and to transmit the instructions to a processing element configured to receive the instructions transmitted by the system manager. The processing element is configured to execute the instructions, wherein execution of the instructions by the processing element decodes the set of coded video data into decoded video data.

### BACKGROUND OF THE INVENTION

1. Field of the Invention

The present invention generally relates to data processing techniques and, in particular, to a system for storing coded content and associated decoding instructions on a removable storage medium.

2. Related Art

Many computer systems have the capability of receiving data stored in coded files and of playing the content defined by the received data files. For example, the data that defines the video content on a removable memory media, such as a digital video disc (DVD) can be compressed, encrypted, or otherwise manipulated to add certain characteristics to the data. The data is typically stored in a data file with these certain characteristics. Such manipulation can be generally referred to as “coding” the data. To retrieve the coded data, the data is “decoded.” For example, if the original data is compressed, the data is decompressed before use. Compressing the data can optimize the available memory space on a DVD disc, and encrypting the data can add a security feature to the content. Further, the data can be both compressed and encrypted. In this regard, these computer systems usually include a decoding application stored in the computer system's memory. If the data on the removable media is compressed, then the computer system will include the decompression application. If the data on the removable media is encrypted, then the computer system will include a decryption application.

When the content defined by a coded data is to be played, the computer system invokes the appropriate decoding application, which decodes the data file. After decoding, the data file is compatible with conventional play devices capable of producing the content from the decoded data.

Consequently, coded data can be downloaded from the Internet, for example, and played by a user's computer system, DVD player, motion picture experts group (MPEG) audio layer 3 (MP3) player, etc. However, certain security issues arise pertaining to the transfer of data by computer systems. In this regard, most computer systems have the capability of not only playing the content downloaded from an external source, such as the Internet, for example, but also have the capability of copying the data. Therefore, it is possible to download data and to create many unauthorized copies of the data.

While a computer system, such as a personal computer (PC) includes sufficient memory and processing power to host many decoding applications, most portable compact disc (CD) players and DVD players that are generally available do not have the capability of decoding many different data files. In this regard, CD players are designed to be small and lightweight to facilitate transportation and, therefore, do not include user interface devices (such as a mouse, a keyboard or a screen display) and/or the memory and processing capability for selecting and downloading decoding applications. Similarly, DVD players designed for mass production and distribution generally include only limited decoding capability to reduce production cost. Further, while it is possible to store decoding applications in a DVD player during manufacturing of the DVD player, the vast number of newly-emerging coding and decoding applications, along with the inability to update the decoding applications stored on a DVD player, make this prohibitive. Furthermore, due to the vast number of coding and decoding techniques, storing decoding applications in the DVD player during manufacturing would significantly increase the cost of the DVD player. In this regard, additional memory may be required in the DVD player to accommodate the decoding applications, or the decoding applications may be implemented as part of the hardware of the DVD player. Unfortunately, each of these options increases the cost of manufacturing, and it is desirable to avoid these costs, if possible.

Even if decoding applications are stored in the DVD player during manufacturing, compatibility with data files is not guaranteed, as the data files may be coded via new techniques or via techniques incompatible with the decoding applications selected for storage. As a result, most DVD players are not designed to decode data. Instead, most DVD players only process DVDs having data stored in, for example, the widely-available MPEG or MPEG II format, the decompression of which are cost-effectively built into most available DVD players. Unfortunately, existing media players will be unable to decode emerging coding applications.

Thus, a heretofore unaddressed need exists in the industry for providing a system and method of processing coded data such that security of the data can be enhanced and such that portable systems, such as DVD players, can receive, decode and process the coded data.

### SUMMARY OF THE INVENTION

Embodiments of the present invention provide a system and method for processing coded video data stored on removable storage media. In an exemplary embodiment, the system comprises a system manger configured to receive inputs from a user of the system and, in response to the inputs, to read organizational structure information stored on a removable storage medium. The system manager is further configured to identify a set of coded data stored on the removable storage medium based on the inputs and the organizational structure information. The system manager is further configured to retrieve instructions from a decoding application stored on the removable storage medium and to transmit the instructions to a processing element configured to receive the instructions transmitted by the system manager. The processing element is configured to execute the instructions, wherein execution of the instructions by the processing element decodes the set of coded data into decoded data.

Related methods, features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating an example of a computer system that may be used to store audio data onto a removable storage medium.

FIG. 2 is a block diagram illustrating an embodiment of a processing system that plays selected data stored on the removable storage medium of FIG. 1 in accordance with the principles of the present invention.

FIG. 3 is a simplified schematic view illustrating an example of the data format of the information contained on the removable storage medium of FIG. 1.

FIG. 4 is a block diagram illustrating another embodiment of a processing system that plays selected data stored on the storage medium of FIG. 1 in accordance with the principles of the present invention.

FIG. 5 is a flow chart illustrating the architecture and functionality of the system manager depicted in FIG. 2.

FIG. 6 is a flow chart illustrating the architecture and functionality of an embodiment of the invention in which coded video content and a corresponding decoding application are stored on the removable storage medium.

### DETAILED DESCRIPTION OF THE PREFERRED EMBODIMENT

The present invention generally relates to a processing system capable of processing video content defined by coded data stored on a digital video disc (DVD) or other type of removable storage media. Preferably, the processing system is capable of processing data stored in any coded video format. As used herein, the term coding defines any method of electronically altering the data that represents the video content, and the term decoding defines a corresponding method of restoring the coded data to its original uncoded format. Coding can encompass, for example, but not limited to, compression, encryption, etc., and decoding can encompass, for example, but not limited to, decompression, decryption, etc. Therefore, different types of coding methodologies and security features may be used to store the data on the DVD, even if the particular types of methodologies and features were not contemplated when the processing system was designed.

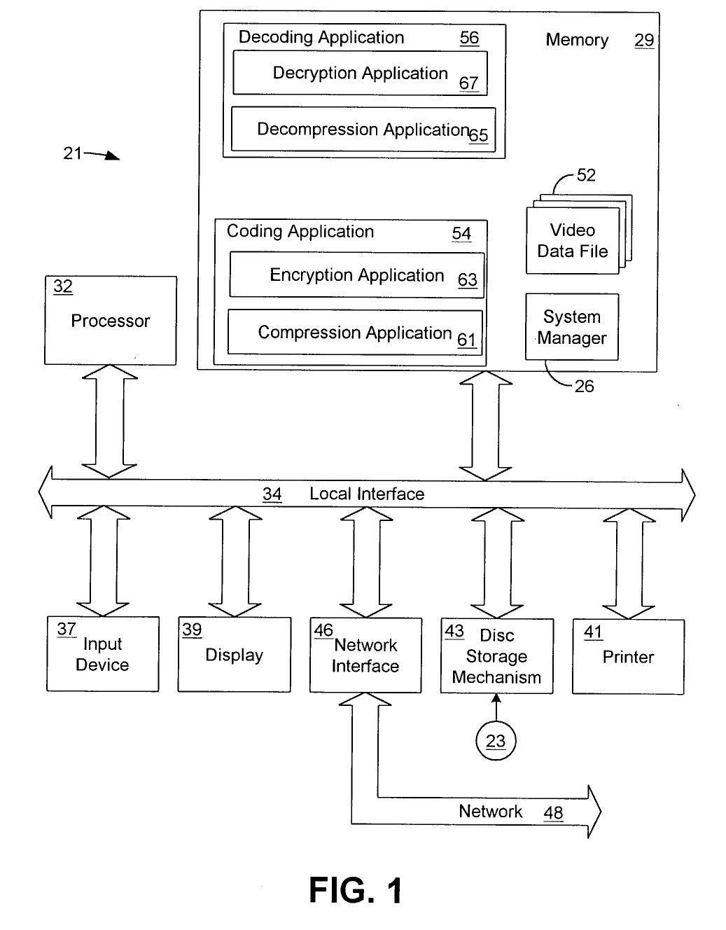

FIG. 1 depicts an example of a computer system 21 that may be used to store data onto a digital video disc (DVD) 23, or other type of removable storage media, according to the principles of the present invention. As used herein, a “removable storage medium” is any medium that may have data stored thereon and that may be transferred to and interfaced with various devices, such as computer systems, players, etc., such that the various devices may read from and/or write to the medium.

The computer system 21 of FIG. 1 includes a system manager 26 configured to control the operation of the system 21. The system manager 26 can be implemented in software, hardware, or a combination thereof In the preferred embodiment, as illustrated by way of example in FIG. 1, the system manager 26, along with its associated methodology, is implemented in software and stored in memory 29 of computer system 21.

The preferred embodiment of the computer system 21 of FIG. 1 also comprises at least one conventional processor 32. The processor 32 communicates with the other elements of the computer system 21 via logical interface 34. The processor 32 can be any custom-made or commercially-available processor, a central processing unit (CPU) or an auxiliary processor among several processors associated with the computer system 21, and a microchip-based microprocessor or a macroprocessor. A suitable processor is one, which can achieve or enable the functionality disclosed herein.

An input device 37, for example, a keyboard or a mouse, can be used to input data from a user of the computer system 21, and screen display 39 or a printer 41 can be used to output data to the user. A disc storage mechanism 43 can be connected to the local interface 34 to transfer data to and from a nonvolatile disc (e.g., magnetic, optical, etc.). The system 21 can be connected to a network interface 46 that allows the system 21 to exchange data with a network 48.

Memory 29 also comprises data files 52, a coding application 54, and/or a decoding application 56. The coding application 54 may comprise a compression application 61, an encryption application 63, or any other coding application. Similarly, the decoding application 56 may include a decompression application 65, a decryption application 67, or any other decoding application. The memory 29 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 106 may incorporate electronic, magnetic, optical, and/or other types of storage media. Note that the memory 29 can have a distributed architecture, where various components are situated remote from one another, but can be accessed by the processor 32.

If used for video content, as in a preferred embodiment, each data file 52 preferably includes data that defines the video content, such as a movie, a video clip, or any other form of video content, and any accompanying audio content. Typically, video content is accompanied by what is referred to as an “audio track” that accompanies the video content. In a typical movie, the video information and the audio information are coordinated so that when played, the video content and the audio content are synchronized. Further, it should be understood that the video content referred to below as data file 52 also includes any accompanying audio content. The data files 52 may be stored in an MPEG or MPEG II format, although other types of formats are possible. The data files 52 can be originally interfaced with the system 21 via many different sources. For example, the data files 52 may be read from a disc in disc storage mechanism 43 or the data files 52 may be downloaded from a network 48, such as the Internet or other type of network.

When desired, the system manager 26 is configured to store selected video data files 52 onto removable storage medium 23, which in the present discussion is a DVD 23 inserted in disc storage mechanism 43. In this regard, a user may input, via input device 37, a request to download selected ones of the video data files 52. In response, the system manager 26 retrieves the selected video data files 52 from memory 29 and stores these video data files 52 onto DVD 23.

Typically, the video data files 52 are in a compressed format (using, for example, MPEG or MPEG II compression) when stored onto DVD 23, although it is possible to store the video data files 52 onto DVD 23 in an uncompressed format. Therefore, if the video data files 52 in memory 29 are in an uncompressed format, the system manager 26 is designed to invoke compression application 61 before transmitting the video data files 52 to DVD 23. When invoked, the compression application 61 is designed to compress the data in the audio data files 52 through conventional techniques. If desired, different types of compression applications 61 may be used to compress the video data files 52. Once the video data files 52 have been compressed, the system manager 26 is configured to store the selected video data files 52 onto DVD 23.

In addition to storing data from the selected video data files 52 onto DVD 23, the system manager 26 is further designed to store a decompression application 65 that includes the instructions for decompressing data from the video data files 52. The decompression application 65 is linked to the selected video data file 52 using a pointer, or other type of mechanism for linking the video file 52 to the decompression application 65. If more than one type of compression technique was used to compress the selected video data files 52, then more than one decompression application 65 may be stored. Therefore, the DVD 23 includes not only data from the selected video data files 52, but it also includes the instructions to decompress this data. Similarly, when a coded video data file 52 is stored on the DVD 23, a decoding application 56 that is capable of decoding the coded video data 52 is also stored on the DVD 23.

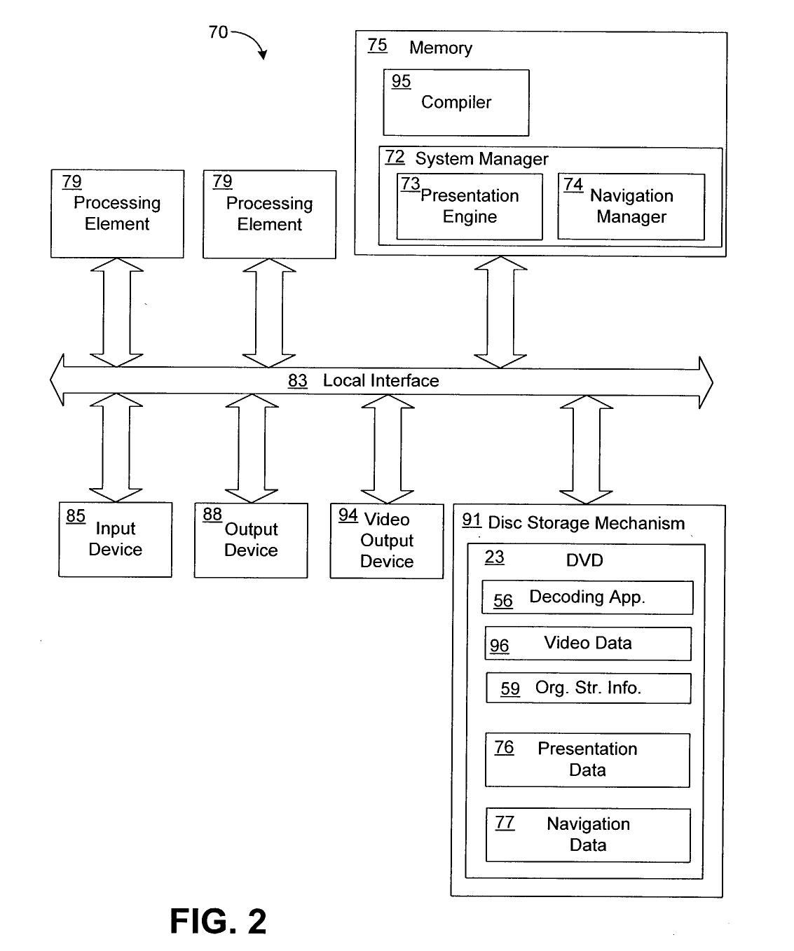

FIG. 2 is a block diagram illustrating an embodiment of a processing system 70 that plays selected data stored on the removable storage medium of FIG. 1 in accordance with the present invention. The system manager 26 (FIG. 1) is also designed to produce organizational structure information 59 and to store the organizational structure information 59 on the DVD 23. The organizational structure information 59 preferably indicates the location of the data from each of the video data files 52 (FIG. 1) stored on the DVD 23, including, in particular, the location of each element of content defined by the video data files 52 stored on the DVD 23. Furthermore, the organizational structure information 59 preferably comprises data defining the title of each video content defined by the video data files 52 stored on the DVD 23.

The organizational structure information 59 may also include data defining one or more play lists. A “play list” as used herein, is a set of data indicating one or more video clips or other video content that are defined by the data stored on DVD 23. In this regard, while selecting which video data files 52 are to be stored on DVD 23 by computer system 21 (FIG. 1), preferably the user may select which content defined by the selected video files 52 are to be included in a particular play list. The user enters inputs via input device 37 indicating which content is to be included into the play list, and the system manager 26, in defining the organizational structure information 59, includes data in the organizational structure information 59 indicating which content has been selected for inclusion into the play list. The organizational structure information 59 may define more than one play list, if desired.

The organizational structure information 59 may also indicate where the decoding application 56 is stored in the DVD 23 and which decoding application 56 should be used to decode the data. For example, if the video data was encoded using compression application 61 (FIG. 1) the data should preferably be decoded using decompression application 65 (FIG. 1). To enable the organizational structure information 59 to be easily located, the system manager 26 in the preferred embodiment is designed to store the organizational structure information 59 in a predetermined location in the DVD 23.

Note that the data from video data files 52 may be stored on DVD 23 in many different formats. For example, among other types of formats, the selected video data files 52 may be stored on the DVD 23 in files using the universal disk format (UDF) data format, as known to those having ordinary skill in the art, or the data from the selected video data files 52 may be stored in tracks defined on the DVD 23, similar to compact disc-digital audio (CD-DA) format. In this regard, in typical UDF format, files of data are defined on the DVD 23. Each file usually contains the video data to play a particular video or video clip, and conventional DVD players have the capability of distinguishing and locating the files on the DVD 23. Therefore, a user specifies which content they prefer, and the DVD player determines which file on the DVD 23 includes the data defining the selected content. Then, the DVD player, using the file as a positional reference, retrieves this data and begins to play the content defined by the data.

Similarly, the video data defining each video data file 52 selected for storage on DVD 23 can be stored in a file of the DVD 23. Furthermore, the decoding application 56 needed to decode the data in a file can either be stored in the file along with the video data or can be stored in a separate file. Accordingly, it should be apparent to one having ordinary skill in the art that the video data from data files 52 and the decoding application 56 can be stored on DVD 23 in a variety of formats.

After storing the data from selected video data files 52, the decoding application 56, and the organizational structure information 59 onto DVD 23, the DVD 23 may be removed from the computer system 21 (FIG. 1) and transported to a processing system 70, such as the one depicted in FIG. 2. In the preferred embodiment, the system 70 is a portable, stand-alone system and includes a system manager 72 configured to control the operation of the system 70. The system manager 72 can be implemented in software, hardware, or a combination thereof. In the preferred embodiment, as illustrated by way of example in FIG. 2, the system manager 72 of the present invention along with its associated methodology is implemented in software and stored in memory 75. The system manager 72 comprises a presentation engine 73 and a navigation engine 74. The DVD 23 includes presentation data 76 and navigation data 77. The presentation engine 73 uses the information in the presentation data 76 to control which files of the DVD 23 are viewed. The navigation engine 74 uses the information in the navigation data 77 to provide a user interface and create menus, etc. Generally, user input via the input device 85 determines the input to the navigation engine 74, which controls the presentation engine 73 to develop the display shown to a user.

The preferred embodiment of the system 70 of FIG. 2 comprises one or more conventional processing elements 79, such as a digital signal processor (DSP), that communicates with and drives the other elements within the system 70 via a local interface 83, which can include at least one bus. Furthermore, an input device 85 can be used to input data from a user of the device 85, and an output device 88 can be used to output data to the user. The DVD 23 is preferably inserted into a disc storage mechanism 91, which can be connected to the local interface 83 to transfer data to and from DVD 23. The system 70 also includes a video output device 94, such as, for example, a video monitor or a television, that may be used to play the content selected from the video data stored in DVD 23.

In this regard, similar to input devices of conventional DVD players, the input device 85 may include buttons or other types of switches that enable a user to select a particular set of video data 96 stored in DVD 23. For example, the input device 85 may have a play button, a stop button, an advance to next selection button and/or an advance to previous selection button. The output device 88 may include a display, such as a liquid crystal display, for example, that indicates the user's selection. Alternatively, the video output device 94 can be used to display selections. For example, if there are five sets of video data to select from, then the video output device 94 may graphically display the five different sets of data, depending on which set of video data 96 is currently selected via input device 85.

As used herein, a “set” of data refers to any logical grouping of data stored on DVD 23. For example, when data is stored on DVD 23 in MPEG format, a set of data may refer to a data file. A set of data may also refer to video content defined by the data stored on DVD 23, and a set of data may refer to a particular play list. It should be noted that a set of data may refer to other types of logical groupings of data.

The user preferably manipulates the buttons or switches in the input device 85 to select a set of video data 96 stored on DVD 23. Selection of a set of video data 96 may be accomplished in a variety of ways. For example, in one embodiment, the system manager 72 is designed to read the organizational structure information 59 when the DVD 23 is loaded into the disc storage mechanism 91 to determine which content are stored on DVD 23. The system manager 72 then transmits data to output device 88 indicating which contents are stored on DVD 23. The user then selects via input device 85 the desired content.

To play video content selected by the user, the system manager 72 retrieves the data defining the video content from DVD 23 and transmits the retrieved data to video output device 94, which produces video and audio signals based on the data. In this regard, the system manager 72 is designed to read the organizational structure information 59, which, as previously described, is stored at a predetermined location in DVD 23. The system manager 72 is then designed to determine, based on the organizational structure information 59, where the set of video data 96 defining the selected content is located on DVD 23 and where the decoding application 56 needed to decode this data 96 is located on DVD 23. Then, the system manager 72 is designed to retrieve the foregoing set of video data 96 and decoding application 56 and to transmit the instructions included in the aforementioned decoding application 56 to at least one of the processing elements 79 for execution.

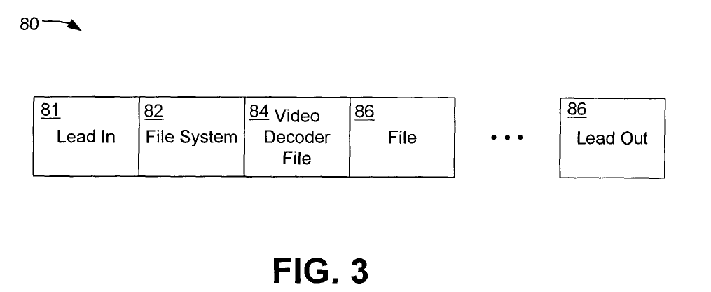

FIG. 3 is a simplified schematic view illustrating an example of the data format of the information contained on DVD 23. The data stream 80 is a simplified example of a UDF file format. The data stream 80 includes a lead-in portion 81, followed by a file system frame 82. The file system frame 82 is followed by one or more file blocks. The file blocks are hierarchically arranged, and can include, for example, a video title set (VTS) block, which contains information about the title, followed by one or more video object sets (VOBSs). A first video object set block 84 may include a video decoder file. The video decoder file 84 may be linked to a VOBS by the presentation data 76. The presentation data 76 can include information defining which decoding application 56 to associate with a particular set of video data 96.

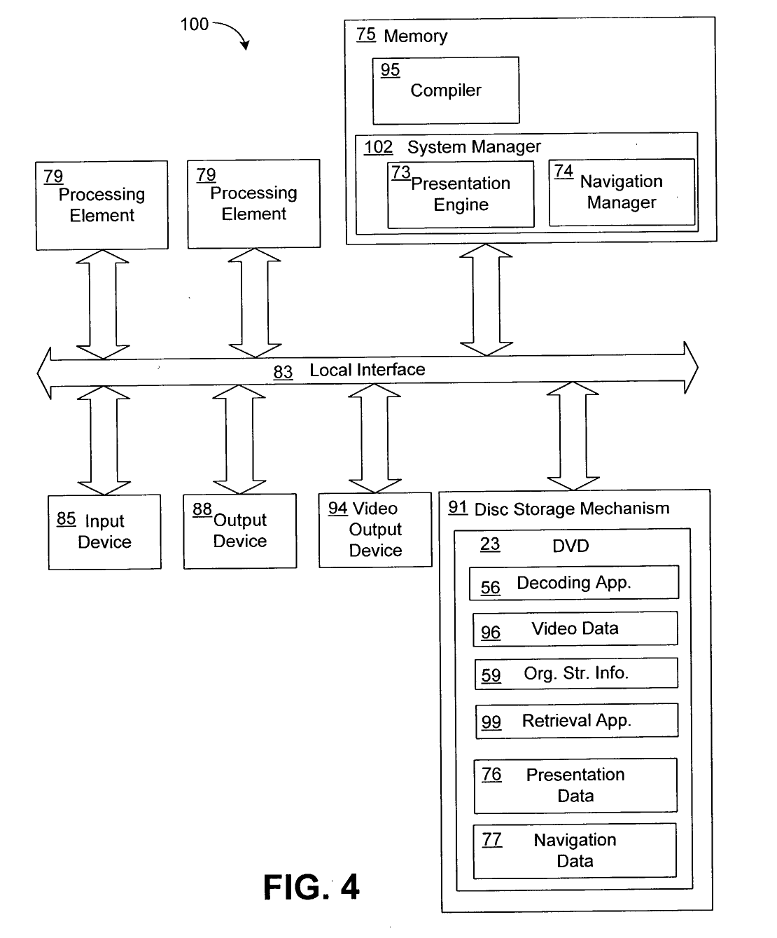

The video object set block 84 is followed by one or more file blocks. The last file block is followed by a lead-out block 86. Referring again to FIG. 4, the execution of the instructions defined by the decoding application 56 decodes the retrieved set of video data 96 defining the selected content. Therefore, the system manager 72 need not have specific logic for decoding the selected data 96, since the instructions for decoding the data 96 are included in the DVD 23. When the user selects a play list, the system manager 72 is designed to read the organizational structure information 59 to determine which content is included in the play list and to begin consecutively playing this content according to the techniques described above.

It should be noted that it is possible to embed the decoding application 56 in the video data stored on DVD 23. For example, the beginning of each data file or track on DVD 23 may include the decoding application 56 used to decompress the video data stored in the remainder of the data file or track. Therefore, system manager 72 need not make a separate determination of the location of the decoding application 56, since the system manager 72 should be aware of the application's location by virtue of being aware of the location of the data file or track. Furthermore, the decoding application 56 can be stored at other predetermined locations on DVD 23, and the system manager 72 can be configured to automatically retrieve the decoding application 56 from a predetermined location on DVD 23 without consulting the organizational structure information 59.

System manager 72 to video output device 94 transmits the uncoded data produced by execution of the decoding application 56 described above. The video output device 94 then produces sounds images and sounds based on the received data. In this regard, the video output device 94 may include a television, or a video monitor and an associated audio processing system, such as an analog-to-digital converter, an amplifier, and speakers, among other devices and/or circuitry for producing image and sound based on the received data.

Furthermore, since the instructions for decoding the set of video data 96 are located on the same medium (i.e., DVD 23) as the set of video data 96, it is possible to include many security features that would not otherwise be possible. For example, the video data can be originally compressed via a unique or not commonly known compression technique. As an example, a seller who desires to sell the video data to a buyer can compress the video data via a compression technique of the seller's own design. Accordingly, widely used decompression applications should not be able to properly decompress the video data. Only a decompression application provided by the seller should properly decompress the video data.

As such, the seller includes the decompression application 65 along with the video data (e.g., stores the decompression application 65 on the medium along with the video data, transmits both the decompression application 65 and the video data file 52 to the buyer over the Internet or other network, etc.). Furthermore, since the seller designed the compression techniques, the seller can implement watermarking techniques within the decompression application 65 to prevent the decompression application 65 from being copied more than a predetermined number of times. Consequently, the number of unauthorized copies that can be successfully made is limited.

Since the instructions for decoding the video data are located on the DVD 23, the number of systems 70 capable of interfacing with the DVD 23 may be limited. In this regard, the processing element 79 used to execute the decoding application 56 is preferably compatible with the instructions in the decoding application 56 unless the decoding application 56 is capable of translating the instructions into a compatible form.

To increase the number of systems 70 compatible with the decoding application 56, the instructions defining the decoding application 56 are preferably stored on the DVD 23 in a relatively high level form, such as, for example, C, which can be compiled into a lower level form compatible with a relatively large number of processors. Therefore, a compiler 95 is preferably stored in memory 75 that compiles the decoding application 56 into a form compatible with the processing element 79 before execution of the decoding application 56. Consequently, as long as the decoding application 56 is compatible with compiler 95, the system 70 is capable of interfacing with the DVD 23 regardless of what type of processing element 79 is utilized by system 70 (provided, of course, that the compiler 95 is designed to translate code into a form compatible with processing element 79).

Compiling the decoding application 56 may utilize a relatively large amount of processing power of the system 70. Consequently, it may be advantageous to include at least two processing elements 79, as shown by FIG. 2, where one of the processing elements 79 is dedicated for compilation of decoding applications 56 stored on the DVD 23 and the other processing element 79 executes instructions pertaining to other functionality performed by the system 70. Alternatively, the two processors 79 may execute in parallel.

In another embodiment of a processing system according to the present invention, a retrieval application 99 is stored on the DVD 23 in addition to the decoding application 56, the organizational structure information 59, and the video data files 52, as shown by FIG. 4. In response to a request from input device 85 to play a set of data 96, the system manager 102 is designed to locate the retrieval application 99 and to transmit the data in retrieval application 99 to at least one of the processing elements 79. The retrieval application 99 includes instructions that, when executed, locate the selected set of video data 96 based on the organizational structure information 59 and the input provided by the user via input device 85.

The retrieval application 99 is further designed to locate the decoding application 56 used to decode the selected set of video data 96 based on the organizational structure information 59 and to invoke execution of this decoding application 56. Once the selected set of video data 96 has been decoded, the retrieval application 99 is configured to transmit the decoded data to the system 100. The system manager 102 is designed to receive the decoded data and to transmit this data to video output device 94, which produces images and sound signals based on the received data.

Accordingly, this embodiment is similar to the first embodiment except that the functionality of locating and retrieving the requested data in DVD 23 is performed by the retrieval application 99 instead of the system manager 102. As shown by the foregoing embodiments, this functionality may be implemented by the system manager 102, the retrieval application 99, or a combination thereof.

The organizational structure information 59 may include data to indicate the location of the retrieval application 99 so that the system manager 102 can retrieve the instructions to execute application 99. However, if the retrieval application 99 is locatable without accessing the organizational structure information 59, then the organizational structure information 59 may be stored in a predetermined location, or other location, on DVD 23. In such a case, it may be desirable to store the retrieval application 99 in a predetermined location so that it may be easily located.

It should be noted that, similar to decoding application 56, the retrieval application 99 may be stored in a relatively high-level form requiring compilation by compiler 95. Therefore, it may be preferable for compiler 95 to compile the instructions defined by the retrieval application 99 before the instructions can be executed by either of the processing elements 79.

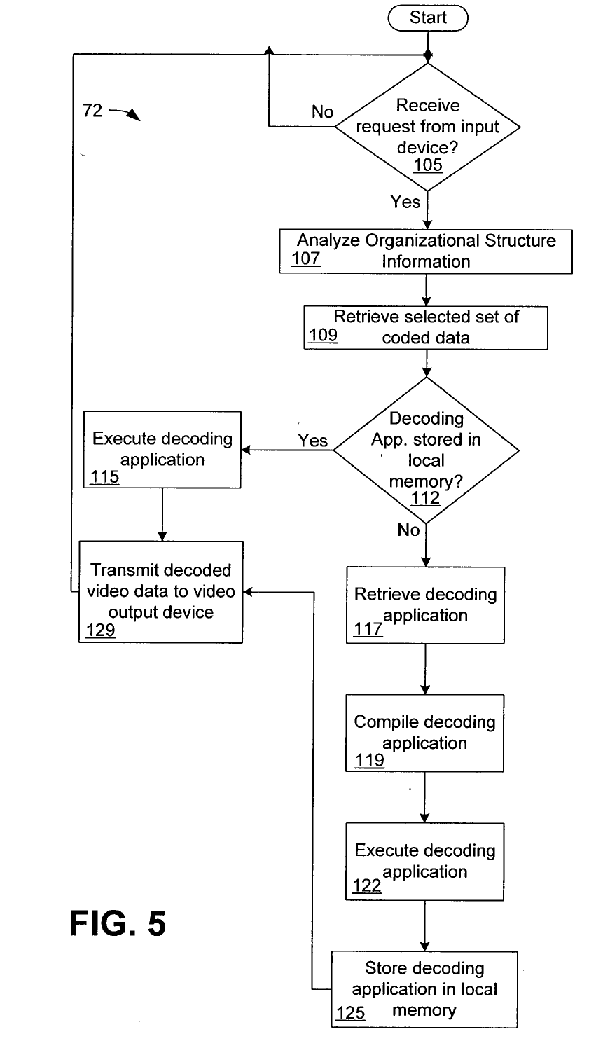

FIG. 5 is a flow chart illustrating the architecture and functionality of the system manager depicted in FIG. 2. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved, as will be further clarified below.

Further, the system and method for processing video content can be implemented in hardware, software, firmware, or a combination thereof. In the preferred embodiment(s), the invention is implemented using a combination of hardware and software or firmware that is stored in a memory and that is executed by a suitable instruction execution system. For example, when a computer system is used to implement the invention, the method for processing video content can be stored in a memory and executed by a processor associated with the computer system, as will be described below.

When implemented in software, the method for processing video content, which comprises an ordered listing of executable instructions for implementing logical functions, can be embodied in any computer-readable medium for use by or in connection with an instruction-execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable-programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Initially, at least one set of video data 96 is stored on DVD 23, or other type of media, via computer system 21 (FIG. 1) or some other type of system. As an example, the set of video data 96 may define a movie selected by the user. In the preferred embodiment, the video data is compressed, although it is possible to store uncompressed video data, if desired. Then, a decompression application 65 is stored on the DVD 23 via the computer system 21. The decompression application 65 comprises instructions that decompress the video data stored on DVD 23 when executed. The computer system 21 is preferably configured to also store organizational structure information 59 on DVD 23 indicating the locations on DVD 23 of the sets of video data 96 and the location of the decompression application 65. The video data may be stored in any suitable format.

The user removes the DVD 23 from system 21 and transfers the DVD 23 to processing system 70, which in the preferred embodiment is a DVD player. Next, the user enters inputs via input device 85 requesting the system 70 to play a particular set of video data 96 stored on DVD 23. In response, the system manager 72 analyzes the organizational structure information 59 to determine where the selected set of video data 96 is located and where the decompression application 65 used to decompress the selected set of video data 96 is located on DVD 23 (assuming the decompression application 65 is not embedded in the set of data 96 as previously described), as shown by blocks 105 and 107 of FIG. 5.

The system manager 72 then retrieves the selected set of video data 96 from DVD 23 in block 109 and determines in block 112 whether the decompression application 65 used to decompress the selected set of video data 96 has been stored in local memory 75. If so, the system manager 72, in block 115, transmits the instructions from the decompression application 65 stored in memory 75 to at least one of the processing elements 79, which executes the instructions to decompress the selected set of video data 96.

If the decompression application 65 is not stored in local memory 75, the system manager 72 retrieves the decompression application 65 from DVD 23 in block 117 and invokes the compiler 95 to compile the decompression application 65 in block 119. The system manager 72 then transmits the compiled instructions of the decompression application 65 to at least one of the processing elements 79 in block 122 to execute the decompression application 65. In block 125, the system manager 72 stores the compiled decompression application 65 in local memory 75 to reduce the amount of time needed to access the decompression application 65 in the future. Alternatively, if the video data is encrypted, the system invokes the decryption application 67 in a similar manner.

Execution of the decompression application 65 should put the selected set of data 96 into a form compatible with video output device 94. In block 129, the system manager 72 transmits this data to video output device 94, which through conventional techniques produces images and sound based on the received data. Therefore, the user is able to see images and hear the audio defined by the selected set of video data 96. Since decompression of the selected set of audio data 96 is performed by decompression application 65, it is not necessary for the system manager 72 (or any other component of the system 70) to be aware of or be compatible with the compression format used to compress the set of video data 96 stored on DVD 23.

It should be noted that storing the decompression application 65 in local memory 75 is not a necessary feature of the present invention but helps to improve performance of the system 70 by decreasing the amount of time required to access the decompression application 65. Furthermore, if the instructions of the decompression application 65 are compatible with the processing elements 79 as stored on the DVD 23, then step 117 is omitted.

The operation of the second embodiment of the present invention described above is similar to the operation of the embodiment just described. However, in the second embodiment, a retrieval application 99 is stored on DVD 23 in addition to the decoding application 56 and the set or sets of video data 96. Furthermore, in response to the user's request to play the selected set of video data 96, the system manager 102 simply locates and invokes the retrieval application 99. In this regard, the system manager 102 transmits the instructions defined by the retrieval application 99 to at least one of the processing elements 79 for execution. If the retrieval application 99 is not in a form compatible with processing element 79, then system manager 102 invokes the compiler 95 to compile the instructions of the retrieval application 99 into a form compatible with processing element 79 before transmitting the instructions to the processing element 79.

Execution of the retrieval application 99 retrieves the selected set of video data 96 from DVD 23 based on the inputs provided by the user and the organizational structure information 59. If the selected set of video data 96 is compressed, then the retrieval application 99 invokes the decompression application 65 during execution to decompress the selected set of video data 96. If the selected set of video data 96 is encrypted, then the retrieval application 99 invokes the decryption application 67 during execution to decrypt the selected set of video data 96.

The retrieval application 99 retrieves the data from the selected set of video data 96 and converts this data into a form compatible with video output device 94. The retrieved data is transmitted to the video output device 94. In response, the video output device 94 produces images and sounds based on the data retrieved from the selected set of video data 96.

Since retrieval of the selected set of video data 96 is performed by retrieval application 99 and decoding application 56 the system manager 102 (or any other component of the device 100) may not be aware of or be able to process the data format of the data stored on DVD 23. Consequently, many different types of data formats may be used to store the data on DVD 23 without affecting the compatibility of the DVD 23 with system 100.

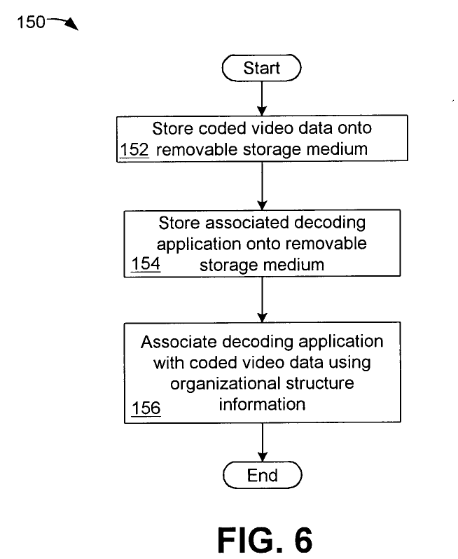

FIG. 6 is a flow chart 150 illustrating the architecture and functionality of an embodiment of the invention in which coded video content and a corresponding decoding application are stored on the removable storage medium. In block 152 at least one set of video data 96 is stored on DVD 23, or other type of media, via computer system 21 (FIG. 1) or some other type of system. As an example, the set of video data 96 may define a movie selected by the user. In the preferred embodiment, the video data is coded. In block 154 an associated decoding application 56 is stored on the DVD 23 via the computer system 21. The decoding application 56 comprises instructions that decode the coded video data stored on DVD 23 when executed. The computer system 21 is preferably configured to also store organizational structure information 59 on DVD 23 indicating the locations on DVD 23 of the sets of video data 96 and the location of the decoding application 56. The video data may be stored in any suitable format. In this manner, the decoding application 56 is associated with the coded video data 96 stored on the DVD 23.

Now, therefore, the following is claimed:

1. A system for processing coded video data stored on removable storage media, comprising:
a system manager configured to receive inputs from a user of said system and, in response to said inputs, to read organizational structure information stored on a removable storage medium, said system manager further configured to identify a set of coded video data stored on said removable storage medium based on said inputs and said organizational structure information, said system manager further configured to retrieve instructions from a decoding application stored on said removable storage medium and to transmit said instructions; and
a processing element configured to receive said instructions transmitted by said system manager and to execute said instructions, wherein execution of said instructions by said processing element decodes said set of coded video data into decoded video data.

2. The system of claim 1, wherein said removable storage medium is a digital video disc (DVD).

3. The system of claim 1, wherein said organizational structure information comprises data defining a location of said decoding application.

4. The system of claim 1, wherein said set of coded video data defines a video movie.

5. The system of claim 1, wherein said decoding application employs a security feature to prevent unauthorized access of said set of coded video data.

6. The system of claim 1, wherein said set of coded video data defines a plurality of video clips.

7. The system of claim 6, wherein said organizational structure information comprises at least one play list indicating a correspondence between said plurality of video clips.

8. The system of claim 1, further comprising:
a compiler configured to receive said instructions and to translate said instructions into a form compatible with said processing element.

9. The system of claim 8, further comprising:
a second processing element configured to receive instructions from said compiler and dedicated to executing said instructions received from said compiler.

10. The system of claim 1, wherein said coded video data is compressed.

11. The system of claim 1, wherein said coded video data is encrypted.

12. The system of claim 1, further comprising a video output device configured to receive said decoded data and to produce images and sound based on said decoded video data.

13. A system for processing coded video data stored on removable media, comprising:
means for reading organizational structure information stored on a removable storage medium;
means for retrieving a set of coded video data from said medium based on said inputs and said organizational structure information;
means for retrieving a decoding application from said medium; and
means for decoding said set of coded video data via said decoding application to produce decoded video data.

14. The system of claim 13, further comprising means for receiving a removable storage medium.

15. The system of claim 13, further comprising means for receiving inputs from a user interface device.

16. The system of claim 13, further comprising means for producing images and sound based on said uncoded video data.

17. A method for processing coded video data stored on a removable storage medium, comprising:
reading organizational structure information stored on a removable storage medium;
retrieving a set of coded video data from said medium based on said inputs and said organizational structure information;
retrieving a decoding application from said removable storage medium; and
decoding said set of coded video data via said decoding application to produce decoded video data.

18. The method of claim 17, further comprising receiving a removable storage medium.

19. The method of claim 18, wherein said removable storage medium is a digital video disc (DVD).

20. The method of claim 17, further comprising:
determining a location of said decoding application based on said organizational structure information; and
performing said retrieving said decoding application based on said determining step.

21. The method of claim 17, wherein said decoding further comprises employing a security feature to prevent unauthorized access of said set of coded video data.

22. The method of claim 17, further comprising:
analyzing said organizational structure information; and
identifying said set of coded video data based on said analyzing.

23. The method of claim 17, further comprising using said set of coded video data to define a video clip.

24. The method of claim 17, further comprising using said set of coded video data to define a plurality of video clips.

25. The method of claim 22, wherein said analyzing further comprises analyzing at least one play list included within said organizational structure information, said at least one play list indicating a correspondence between said plurality of video clips.

26. The method of claim 17, further comprising:
compiling said decoding application subsequent to said retrieving and prior to said decoding.

27. The method of claim 26, further comprising:
performing said compiling via a processing element dedicated to compiling decoding applications stored on said removable storage media.

28. The method of claim 17, further comprising compressing said coded video data.

29. The method of claim 17, further comprising encrypting said coded video data.

30. The method of claim 17, further comprising producing images and sound based on said decoded video data.

31. The method of claim 17, further comprising receiving inputs from a user interface device.

32. A computer readable medium having a program for processing coded video data stored on a removable storage medium, the program comprising logic for:
reading organizational structure information stored on a removable storage medium;
retrieving a set of coded video data from said medium based on said inputs and said organizational structure information;
retrieving a decoding application from said removable storage medium; and
decoding said set of coded video data via said decoding application to produce decoded video data.

33. The program of claim 32, further comprising receiving a removable storage medium.

34. The program of claim 33, wherein said removable storage medium is a digital video disc (DVD).

35. The program of claim 32, further comprising:
determining a location of said decoding application based on said organizational structure information; and
performing said retrieving said decoding application based on said determining step.

36. The program of claim 32, wherein said decoding further comprises employing a security feature to prevent unauthorized access of said set of coded video data.

37. The program of claim 32, further comprising logic for:
analyzing said organizational structure information; and
identifying said set of coded video data based on said analyzing.

38. The program of claim 32, further comprising using said set of coded video data to define a video clip.

39. The program of claim 32, further comprising using said set of coded video data to define a plurality of video clips.

40. The program of claim 37, wherein said analyzing logic further comprises logic for analyzing at least one play list included within said organizational structure information, said at least one play list indicating a correspondence between said plurality of video clips.

41. The program of claim 32, further comprising logic for compiling said decoding application subsequent to said retrieving and prior to said decoding.

42. The program of claim 41, further comprising logic for performing said compiling via a processing element dedicated to compiling decoding applications stored on said removable storage media.

43. The program of claim 32, further comprising logic for compressing said coded video data.

44. The program of claim 32, further comprising logic for encrypting said coded video data.

45. The method of claim 32, further comprising logic for producing images and sound based on said decoded video data.

46. A method for storing coded video data on removable storage media, comprising:
storing coded video data onto a removable storage medium;
storing a decoding application on the removable storage medium; and
storing organizational structure information on said removable storage medium, said organizational structure information linking said decoding application to said coded video data.
